(19) United States
(12) Patent Application Publication
(10) Pub. No.: US 2006/0064922 A1
(43) Pub. Date: Mar. 30, 2006

(54) Safety disposable mouse trap

(76) Inventors: Jacquelyn R. Crispens, Cottage Hills, IL (US); Jack B. Crider SR., Cottage Hills, IL (US)

Correspondence Address: Raymond M. Galasso;Galasso & Associates LP, P.O. Box 26503, Austin, TX, 78755-0503, US

(21) Appl. No.: 11/232,832

(22) Filed: Sep. 22, 2005

Related U.S. Application Data
(60) Provisional application No. 60/613,048, filed on Sep. 27, 2004.

(51) Int. Cl. A01M 23/30

(52) U.S. Cl. 43/81.5; 43/81

(57) ABSTRACT

This product is designed to provide a disposable spring-loaded mouse trap with a safety arm to prevent accidental discharge of the bow of a spring-loaded mouse trap. The safety disposable mouse trap consists of a lever, screw attachment, safety arm, and other conventional spring-loaded mouse trap elements. A user can rotate the safety arm with the lever to permit the bow of the mouse trap to rotate unimpeded after the trap is set.

### CROSS REFERENCE TO RELATED APPLICATIONS

This Non-Provisional Patent Application claims priority to U.S. Provisional Application Ser. No. 60/613,048 filed on Sep. 22, 2004 entitled “Safety Disposable Mouse Trap.”

### FIELD OF THE DISCLOSURE

The disclosures made herein relate generally to rodent removal systems. The invention discussed herein is in the general classification of mouse traps.

### BACKGROUND

Rodent removal systems and mouse traps have been utilized for many years to catch, trap, or kill rats and mice in houses and offices. There are many well know types of rodent removal systems. Some of the most common include: spring loaded traps, poisons, glue trays, electronic traps and even a household pet.

Unfortunately, all of these rodent removal systems have serious drawbacks. Traditional spring-loaded traps are by far the most common type of trap. However, these devices can be unsafe to use because they are difficult to set and can cause injury to the person setting the trap if the bow swings shut inadvertently during the setting process.

Several substitutes to the spring-loaded traps have been invented, but these also have significant disadvantages. For example, glue trays that have a sticky substance coated over plastic or some other material can be used to trap mice or rats. These glue trays can be messy to use and can also inadvertently get caught on a child or household pet, causing the user to have to undertake a laborious cleaning and removal process.

Rat poisons have also been used to kill unwanted rodents. However, the chemicals contained in rat poisons can be dangerous to humans or household pets.

Electronic traps have also been employed to kill rodents. These units emit high voltage shocks to the rodents when they touch metal plates that have been coated with bait. However, these units can also be unsafe to use with children or household pets in the house. Also, because these units have electrical components and require batteries, they can be expensive to operate.

The old-fashioned solution of having a household pet, such as a cat, to catch rodents also has several drawbacks, including the expense and hassle of caring for such a pet.

### SUMMARY OF THE DISCLOSURE

In general, the Safety Disposable Mouse Trap operates in the same manner as a traditional spring-loaded trap. However, the Safety Disposable Mouse Trap is safer than a traditional spring-loaded mouse trap because it utilizes a safety arm to prevent the bow from accidentally discharging and injuring the user.

In one embodiment of the invention, the safety arm with operating lever is simply screwed into the base of the traditional spring-loaded trap permitting the safety arm to hang over the bow. In the event of an accidental discharge, the safety arm will catch the bow and prevent injury to the user. After the mouse trap is set, the user can simply rotate the safety arm with the lever to move the safety arm out of position so it no longer interferes with the recoil of the bow.

Although the device described herein is often referred to as a mouse trap, it should be understood that such a device could be used to trap any number of animals of appropriate size.

The principal object of this invention is to provide a safe, spring-loaded mouse trap.

Another object of this invention is to provide an affordable spring-loaded mouse trap.

Another object of this invention is to provide an aesthetically pleasing spring-loaded mouse trap.

Another object of this invention is to provide a spring-loaded mouse trap that is easy to use.

Yet another object of the invention is to provide a lightweight and durable spring-loaded mouse trap.

### BRIEF DESCRIPTION OF THE DRAWINGS

FIG. 1 depicts a perspective view of the safety mechanism for the safety disposable mouse trap.

FIG. 2 depicts a perspective view of the safety disposable mouse trap.

### DETAILED DESCRIPTION OF THE DRAWINGS

The mouse trap of the present invention is comprised of at least some of the following: a safety arm, collar and threaded screw attachment, lever, and traditional spring-loaded mouse trap components.

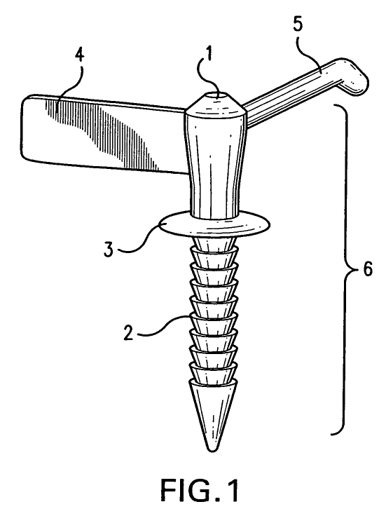

In the preferred embodiment of the safety mechanism 6 for the invention, shown in FIG. 1, a screw attachment 1 has threads 2 extending from the bottom of the screw attachment 1 to the collar 3. The distance from the bottom of the screw attachment 1 to the collar 3 is approximately the same as the thickness of the base of a conventional spring-loaded mouse trap. A lever 4 is located above the collar 3 and attached to the top portion of the screw attachment 1. A safety arm 5 is also located above the collar 3 and attached to the top portion of the screw attachment 1. The safety arm 5 is angled approximately ninety (90) degrees apart from the lever 4 in the same horizontal plane as the lever 4.

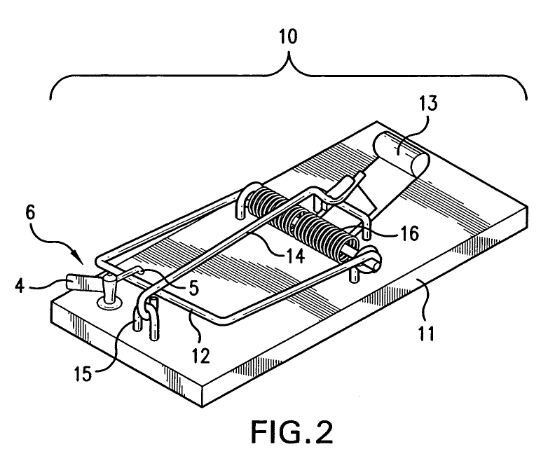

FIG. 2 depicts the preferred embodiment of the safety disposable mouse trap 10 of the current invention. The safety mechanism 6 is anchored to the base 11 of the safety disposable mouse trap 10 at the end of the base 11 with the cocked bow 12 and the wire hook 15 but opposite the end of the base 11 with the bait pedal 13. The safety arm 5 of the safety mechanism 6 is positioned directly above the cocked bow 12. The screw attachment of the safety mechanism is anchored to the base 11 such that the lever 4 used to reposition the safety arm 5 is located outside the swing path of the bow 12. Ideally, the threads of the screw attachment for the safety mechanism 6 will penetrate the entire base 11 until the collar of the screw attachment approximately contacts the top of the base 11 of the safety disposable mouse trap 10.

The bow 12 is attached to or overlapping a coil spring 16. The coil spring 16 and bow 12 are centrally attached to the base 11. The bow 12 can be held in place in a cocked position with the use of a locking bar 14 attached on one end to the wire hook 15 and on the other end to a v-shaped lip on the bait pedal 13. The front of the bait pedal 13 next to the coil spring 16 is anchored to the base 11 in a manner that permits the bait pedal 13 to rotate upward toward the cocked bow 12.

The Safety Disposable Mouse Trap operates in much the same manner as a conventional spring-loaded mouse trap with a few modifications that make it safer for the user. With a conventional spring-loaded mouse trap, the user places bait inside or on a bait pedal and then pulls back the bow and holds it down with a thumb while engaging the locking bar over the cocked bow and under the V-shaped lip of the bait pedal with the other hand. However, if a user's thumb slips while setting the locking bar, the bow will violently swing forward potentially harming the user.

The Safety Disposable Mouse Trap can be shipped with the bow already spring loaded, the bait pedal scent baited, and the safety mechanism in place. The user simply needs to position the mouse trap with the bait pedal nearest to a wall and then rotate the lever on the safety mechanism to move the safety arm out of the swing path of the bow. If the spring loaded bow has accidentally discharged during shipping it can be reset in the same manner as the conventional mouse trap with the safety arm in place to prevent any injuries should an accidental discharge occur again.

It should be understood that the safety mechanism of the current invention could be employed on a variety of spring-loaded animal traps. Any device that has a cocked striking arm that can be caught by a safety arm when inadvertently fired can utilize the safety mechanism of the current invention.

The entire animal trap and removal system also includes a non-transparent, sealable bag that will prevent the user from having to view or smell the animal after it is captured or killed. The entire trap can simply be put into the non-transparent, sealable bag and discarded.

In yet another embodiment of the trap and removal system, a disposable glove and flavored bait will also be included.

The materials utilized for Safety Disposable Mouse Trap can vary widely but will often utilize standard spring-loaded mouse trap components. These standard parts may include: plastic, wood, springs, and metal components.

For example, plastic may be used in the production process of the bait pedal. The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The Safety Disposable Mouse Trap will be offered in a variety of sizes and colors. The preferred embodiment will be a glow in the dark device. Because the device glows in the dark, users can avoid contact with and accidental discharge of the device even at night.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. An animal trap comprising:
(a) a base;
(b) a screw attachment anchored to the base;
(c) a lever located on the screw attachment;
(d) a safety arm located on the screw attachment and maneuverable over a bow; and
(e) said bow connected to a coil spring and attached to the base in a manner that allows the bow to be held in a cocked position with the use of a locking bar attached on one end of the base to a wire hook anchored to the base and on the other end to a lip on a bait pedal anchored to the base.

2. The animal trap of claim 1 wherein the screw attachment is anchored to the base such that the lever is located outside the swing path of the bow.

3. The animal trap of claim 1 further comprising
a collar located on the screw attachment.

4. The animal trap of claim 3 further comprising
a thread pattern extending from the bottom of the screw attachment to the collar.

5. The animal trap of claim 3 wherein the distance from the bottom of the screw attachment to the collar is approximately the same as the thickness of the base.

6. The animal trap of claim 1 wherein the base glows in the dark.

7. The animal trap of claim 1 wherein the safety arm is angled approximately ninety degrees apart from the lever in the same horizonal plane.

8. The animal trap of claim 1 wherein the coil spring and the bow are approximately centrally attached to the base.

9. The animal trap of claim 1 wherein the lip of the bait pedal has a v-shape.

10. An animal removal system comprising:
(a) a base;
(b) a screw attachment anchored to the base;
(c) a lever located on the screw attachment;
(d) a safety arm located on the screw attachment and maneuverable over a bow; and
(e) said bow connected to a coil spring and attached to the base in a manner that allows the bow to be held in a cocked position with the use of a locking bar attached on one end of the base to a wire hook anchored to the base and on the other end to a lip on a bait pedal anchored to the base;
(f) a bag that is non-transparent and sealable;
(g) a bait pellet; and
(h) a glove.

11. An animal trap comprising:
(a) a base;
(b) a screw attachment anchored to the base;
(c) a lever located on the screw attachment;
(d) a safety arm located on the screw attachment and maneuverable over a striking arm; and
(e) said striking arm connected to a coil spring and attached to the base in a manner that allows the striking arm to be held in a cocked position with the use of a locking bar attached on one end of the base to a wire hook anchored to the base and on the other end to a lip on a bait pedal anchored to the base.
